(19) United States
(12) Patent Application Publication
(10) Pub. No.: US 2002/0145046 A1
(43) Pub. Date: Oct. 10, 2002

(54) Multifunction optical mouse

(76) Inventors: Kenneth Liou, Hsin-Tien (TW); Ho-Yeh Yu, Hsin-Tien (TW)

Correspondence Address: BIRCH STEWART KOLASCH & BIRCH, PO BOX 747, FALLS CHURCH, VA, 22040-0747, US

(21) Appl. No.: 09/828,867

(22) Filed: Apr. 10, 2001

(51) Int. Cl. G06K 7/10

(52) U.S. Cl. 235/462.46

(57) ABSTRACT

A multifunction optical mouse compromising a hollow enclosure containing two mechanisms: a movement tracking mechanism and a bar code scanning mechanism. On and off a switch on the mouse enclosure switches the mouse to the mouse cursor indication function or the bar code scanning function. The output port of the mouse connects to outside devices either through a wire or wireless mechanism.

### BACKGROUND OF THE INVENTION

I. Field of the Invention

This invention relates generally to a multifunction optical computer mouse, more specifically, a combination of computer cursor indicator and optical bar code reader. This invention equips mouse with multiple functions, it also reduces the numbers of computer peripherals and the correspondent computer input/output ports needed.

II. Description of the Prior Art

With the popularity of network and multimedia applications, new electronic equipment keeps coming out, includes new model of computers and computer network devices. With the development of newer technologies and special functions, there are more and more peripheral equipment, from the basic instruction input, printing output functions to on-line Internet, multimedia applications. How to properly link and control all the peripherals with different functions and different input output formats challenges the computer users. Take PC for example, besides the basic input output ports, a new function has to take an I/O slot to add a new card; video display needs a video card, network has to use a network card, speakers link to sound card. With the increasing peripheral equipment, it not only becomes a problem to properly place those bulky devices, but also a challenge to the users how to connect all the equipment to the PC and arrange all the wires and cables properly. The number of I/O slots inside the PC is limited; it is impossible to expand all the functions without restriction, how to connect more peripheral equipment in the limited expansion environment becomes a headache for all the end users. Therefore, how to reorganize different peripheral equipment with different functions, make computers more efficient and support more functions, is a challenge for the manufacturers.

Bar code is now considered the best merchandise management system for product sorting, incoming and outgoing control. By sticking a bar code label on the products, it is very easy to identify, store and manage all the products by scanning the merchandise with the bar code reader. However, it is necessary to put a bar code reader add-on card on the PC slot. The problem mentioned above happens: one PC slot is occupied and one more peripheral appears, the troublesome of arrangement of more wires. It is necessary to find a better way for cost saving and easier wire management.

### SUMMARY OF THE INVENTION

It is therefore a primary object of the invention to provide a multifunction optical mouse. The mouse not only have movement tracking mechanism for cursor indication, but also equipped with bar code reading mechanism for bar code scanning function. Such arrangement makes a mouse with more functions and more user friendly.

A further object of the invention is to reduce the numbers of computer peripherals and the correspondent computer input/output ports needed. Such mechanism makes the arrangement of PC slots, I/O ports and wires easier to manage.

### BRIEF DESCRIPTION OF THE DRAWINGS

FIG. 1 is a top view, partially in section, of a pen-type scanner according to the present invention.

FIG. 2 is an enlarged view of the bar code scanning mechanism in accordance with the present invention;

FIG. 3 is the right-side sectional view of the present invention;

FIG. 4 is a flow chart of the barcode signal according to the present invention;

FIG. 5 is a sectional assembling view of another embodiment of the bar code scanning mechanism in accordance with the present invention.

### DESCRIPTION OF THE PREFERRED EMBODIMENT

This invention has a hollow shell enclosure; the enclosure has two parts: an upper shell and a flat bottom. On the front edge of the upper shell, there are covers of the push buttons. There is an electrical circuit board between the upper shell and flat bottom, the movement tracking mechanism and bar code scanning mechanism are on the electrical circuit board. The bar code scanning mechanism consists of scan source light, light focus element, optical signal receiving/converting device and electrical circuitry. In order to get closer to the bar code label, the scanning tip of the bar code scanning mechanism is placed through an open hole in the rear of the enclosure. The rest of the bar code scanning mechanism is connected to the circuit board, so the scanned signal can be transmitted to the computer through the circuit board.

Based on above description, this invention applies the source light on the bar code scanning mechanism, let the light passes through scanning tip (or a lens) to the surface of the bar code label; the reflection passes through scanning tip, and focused by the light focus element. The focused images fall on the optical signal receiving/transforming device; the optical signal receiving/transforming device reads the optical images and converts those into digital signals. The circuitry of the bar code scanning mechanism connects together with the movement tracking circuitry, they can share the exited output interface and output wire to transfer the scan bar code data to the computer.

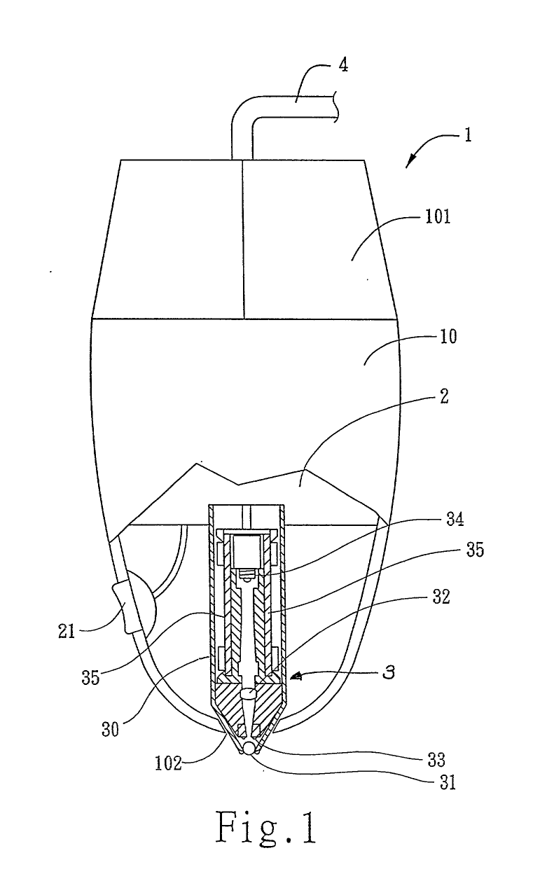

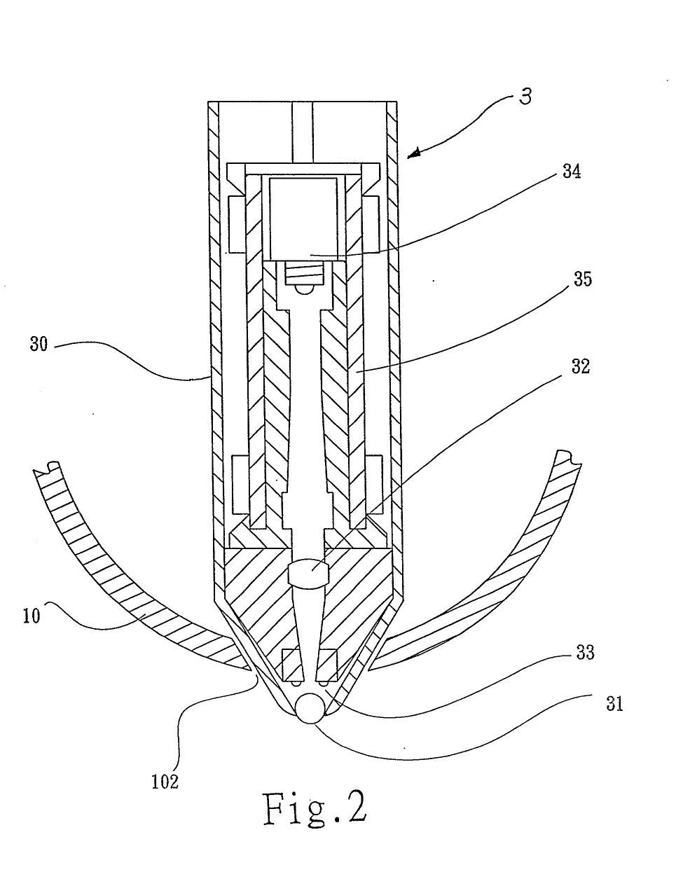

Referring to FIG. 1 to FIG. 3, the present invention multifunction optical mouse 1 is composed of an enclosure 10, an electrical circuit board 2, a bar code scanning mechanism 3 and an output wire 4. The details of each component are described as following:

The enclosure 10 consists of an upper shell and a flat bottom. On the upper shell, there are several covers 101 of the push buttons near the output wire 4; there is an open hole 102 on the rear (usually, the open hole is on the center), this hole is for bar code scanning purpose. On the flat bottom, there is another track ball hole 103, this hole holds the track ball (not shown in this fig.) to roll smoothly along with the enclosure.

The electrical circuit board 2 lies between the upper shell and the flat bottom of the enclosure. On one end the electrical circuit board 2 connects to the output wire 4, on the other end, it connects to the bar code scanning mechanism 3. The signal output portion can connect a wireless transmitting circuitry (not shown in this fig.) instead of a wire to transfer the signals to computer with infrared.

There are several electronic components and other parts (not show in this fig.) on this electrical circuit board 2. When users move the mouse 1, the track ball rolls along, those parts and components record the moving tracks and convert those tracks into control signals and pass signals through output wire 4 to computer.

There is a push button (not show in this fig.) beneath every push button cover 101 on the upper shell. Users can press the push button to issue computer instruction on different cursor locations.

On the electrical circuit board 2 adjoin to the bar code scanning device 3, there is a switch 21; this switch controls and transfers bar code data read by the bar code scanning device 3. When switch 21 is not pressed, mouse 1 executes the original operation: keeps tracks of mouse movements and converts the movements into digital signals, sends those signals to computer and terminal to indicate the cursor locations. When switch 21 is pressed, the power of bar code scanning device 3 is activated, the light source 33 emits light beam to scan bar code label 5; the bar code scanning device 3 receives the reflected bar code data, converts and transmits those to computer through output wire 4.

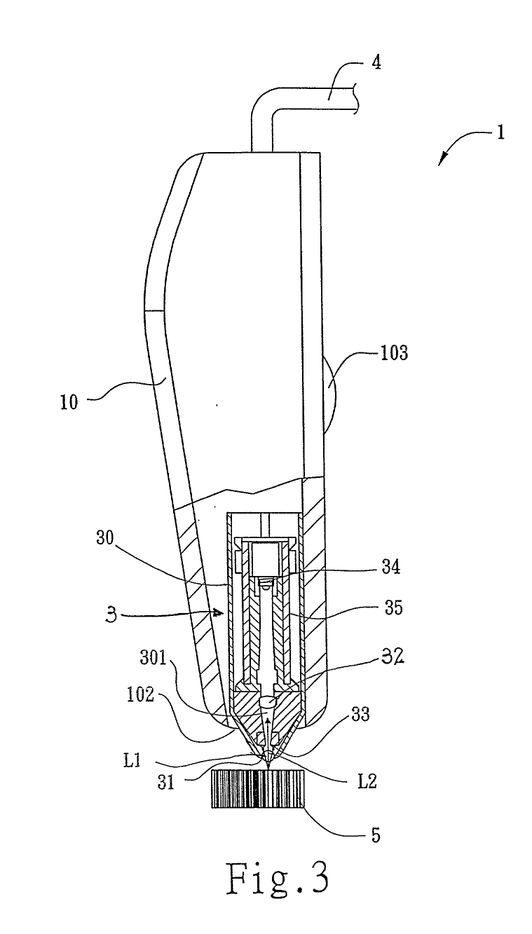

Referring to FIG. 3, the bar code scanning device 3 is modularized and packed inside a hollow covering 30. On top of this covering 30, there is a scanning tip 31 to contact or approach close to bar code label. Inside the scanning tip 31, there is an empty round hole or a convex lens. The scanning tip 31 is designed to place on the rear hole 102 of the mouse enclosure 10. There is a light passage 301 near the back of scanning tip 31 inside covering 30; there is light focus element 32, light source 33, optical signal receiving/converting device 34 and circuit board 35 inside this covering 30. The light focus element 32 is located inside the light passage 301, it is normally a convex lens. The convex lens focuses and conducts the reflected images come from scanning tip 31 and light passage 301 to optical signal receiving/converting device 34 in the end of light passage 301. The optical signal receiving/converting device 34 is composed of light receiving transistors and other optical components, it reads the optical images sent by light focus element 32; the optical images are then converted into digital signals by circuit board 35. The circuit board 35 is inside the enclosure 10 and connects to the electrical circuit board 2; the scanned bar code data go through electrical circuit board 2 and transmit to computer. The light source 33 is inside the covering 30; normally it is placed beside the light passage 301 and between scanning tip 31 and light focus element 32. The light source 33 is composed of one or more LED's (Light Emit Diode), if there is more than one LED, the LED's can be placed on the edge of the covering 30 and symmetrically along the center line of the covering 30. While scanning, the light source 33 is turn on; the LED light pass through the empty hole or convex lens in the scanning tip 31 and reach bar code label 5 to scan the data.

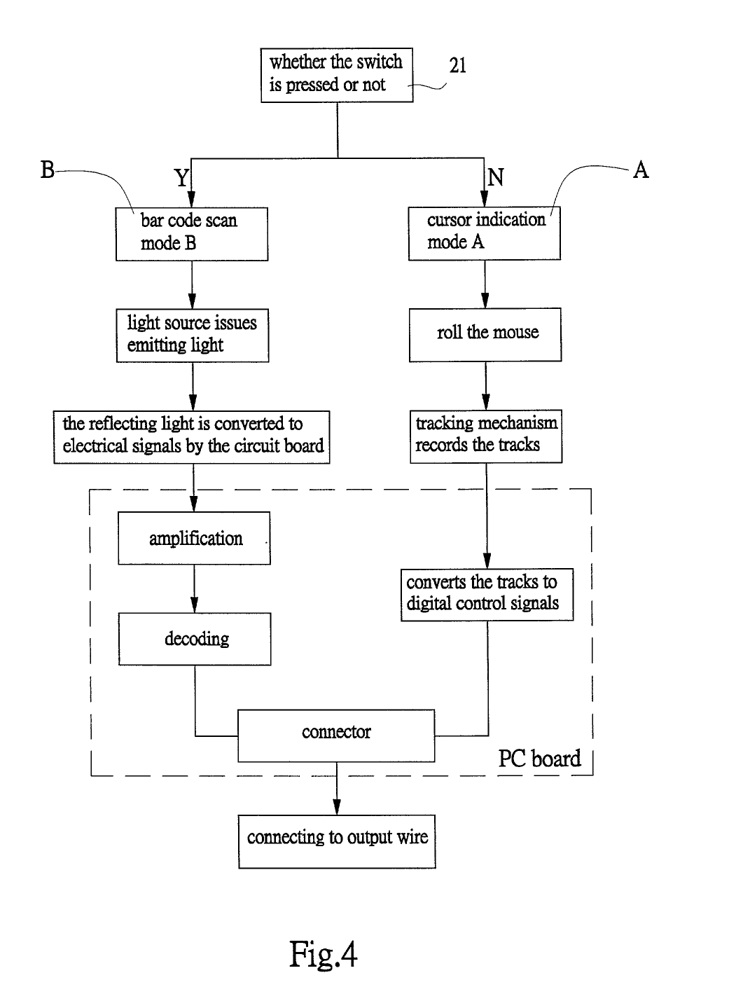

Referring to FIG. 4, when the switch 21 is not pressed, the mouse 1 is in cursor indication mode A. The users place the mouse 1 in a flat surface and roll, the track ball in the movement tracking mechanism also moves along. The movement tracking mechanism records the tracks and converts those to digital control signals, and passes the converted signals to computer and terminal through output wire 4 to indicate the cursor location. Referring to FIG. 3, while scanning, users lift the mouse 1, aim bar code label 5 with scanning tip 31 on top of the hole 102, then press switch 21, switch the mouse 1 into bar code scan mode B. The light source 33 issues emitting light L1, emitting light L1 pass through the empty hole or convex lens to the bar code label 5. The reflecting light L2 with images of the black and white bars come back through the hole in scanning tip 31 and enter light focus element 32. When the reflecting light L2 reach the optical signal receiving/converting device 34, those are converted to electrical signals by the circuit board 35; the electrical signals are then transferred to the circuit board 2 of mouse 1. The circuit board 2 converts the electrical signals to other proper formats: keyboard, RS232 or USB (Universal Serial Bus) depended on the corresponding mouse port connected, the processed digital signals are transmitted to computer through output wire 4.

By above description, this invention offers the both functions of computer cursor indicator and optical bar code scanner. It also avoids the problem that the bar code scanner needs to occupy one PC expansion slot.

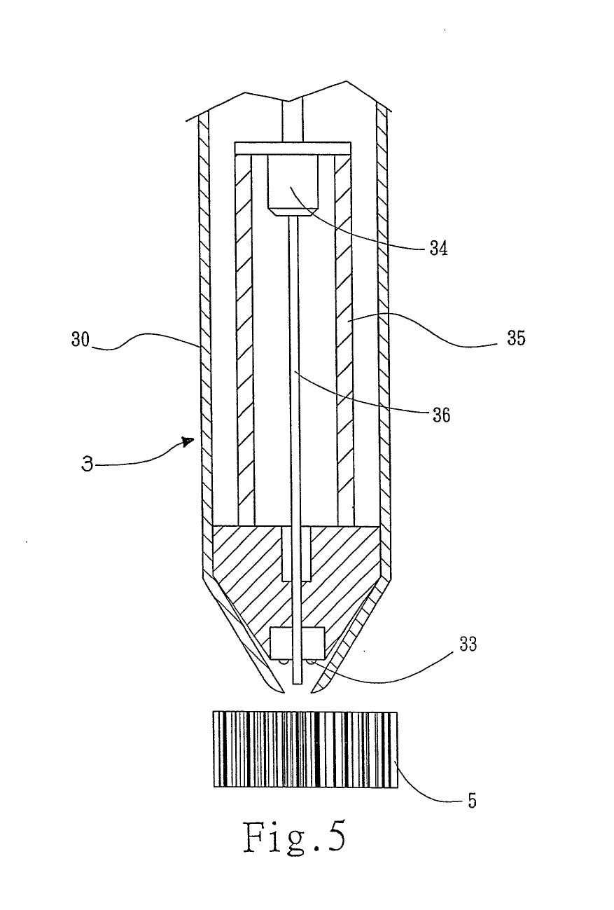

The bar code scanning mechanism mentioned above can be other formats; referring to FIG. 5, the light passage and light focus element (convex lens) can be replaced by fiber optics component 36. The better light conducting quality of fiber optics assures the optical signal receiving/converting device 34 effectively receives more accurate reflecting light images.

The movement tracking mechanism of this invention can be optical instead of mechanical that can reduce the tracking ball and other relative mechanical parts.

While a preferred embodiment of the invention has been shown and described in detail, it will be readily understood and appreciated that numerous omissions, changes and additions may be made without departing from the spirit and scope of the invention.

What is claimed is:

1. A multifunction optical mouse compromising:
an enclosure composed of an upper shell and flat bottom, inside the said enclosure contains:
a movement tracking mechanism, located close to the track generator, recording and generating track movement signals; and
a bar code scanning mechanism packed modularized, said bar code scanning mechanism including: a scanning tip located on one end of said enclosure, said scanning tip to contact or approach close to the bar code label; a light source located near the back of said scanning tip, generating the light emitting to the bar code label; a light focus element, normally is a convex lens, focusing the reflection comes through said scanning tip; an optical signal receiving/converting device receiving optical images sent by said light focus element; a circuit board connected to said movement tracking mechanism, receiving the images sent by said optical signal receiving/converting device and converting those images to digital signals;
an output port located on one side of said enclosure, receiving signals from said movement tracking mechanism and said bar code scanning mechanism and transmitting signals to outside devices through a proper interface.

2. The multifunction optical mouse as recited in claim 1, wherein said movement tracking mechanism is a mechanical device equipped with a track ball.

3. The multifunction optical mouse as recited in claim 1, wherein said movement tracking mechanism is an optical device without track ball.

4. The multifunction optical mouse as recited in claim 1, wherein said light focus element of said bar code scanning mechanism is a convex lens.

5. The multifunction optical mouse as recited in claim 1, wherein said light focus element of said bar code scanning mechanism is a fiber optics component with better light conducting quality.

6. The multifunction optical mouse as recited in claim 1, wherein said mouse has a switch on one side of said enclosure to switch between mouse cursor indication and bar code scanning functions.

7. The multifunction optical mouse as recited in claim 1, wherein said output port connects to an output wire for connecting outside devices.

8. The multifunction optical mouse as recited in claim 1, wherein said output port connects to a wireless transmitting circuitry.
